(19) United States
(12) Patent Application Publication
(10) Pub. No.: US 2013/0277585 A1
(43) Pub. Date: Oct. 24, 2013

(54) SOLENOID VALVE WITH A PISTON DAMPED ARMATURE

(71) Applicant: Curtis L. Van Weelden, Waukesha, WI (US)

(72) Inventor: Curtis L. Van Weelden, Waukesha, WI (US)

(21) Appl. No.: 13/449,945

(22) Filed: Apr. 18, 2012

(51) Int. Cl. F16K 31/02

(52) U.S. Cl. 251/129.15

(57) ABSTRACT

A valve has a body with two ports and a valve element for controlling fluid flow between those fluid ports. A solenoid actuator includes a moveable armature operatively coupled to the valve element and defining first and second chambers on opposite sides of the armature. A bore extends through the armature between those chambers. A damping piston, slideably located in the bore, has a damping orifice forming a continuously open path there through. A spring biases the damping piston into a normal position in a steady state of the valve and allows bidirectional armature motion therefrom. When the armature moves at low velocity, a pressure increase in one chamber is relieved by flow through the damping orifice. As the armature velocity increases, so too does pressure in the one chamber, causing the damping piston to move relative to the armature, thereby adding damping force from the spring to the armature.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to solenoid operated hydraulic valves and in particular to techniques for damping the operation of such valves.

2. Description of the Related Art

Electrohydraulic valves have been developed for a variety of equipment to selectively apply and exhaust pressurized fluid to and from a component, the operation of which is controlled by that valve. One type of such valve has a spool that slides within a bore. In one position, the spool provides a path between a supply conduit containing pressurized fluid to a workport that is connected to the component being operated by the valve. In another position, the spool provides a path between the workport and an exhaust port to relieve pressure at the workport. In a third position of the spool, the workport is disconnected from both the supply and the exhaust ports.

The spool is driven into the different positions by a solenoid actuator that has an electromagnetic coil within which an armature slides. The armature is coupled to apply force to the spool. Application of the proper level of electric current to the electromagnetic coil generates a magnetic field that causes the armature to move and in turn move the valve spool.

In many installations relatively high fluid pressure acts on the spool and other components of the valve. In a typical valve, the armature moves within a central bore of the solenoid. For that motion to occur, fluid in a chamber on one side of the armature must flow to a chamber on the opposite side of the armature in order to provide space for the armature motion. Typically, the armature has a large central bore through which the fluid easily flows between the two chambers as the armature moves. This allows the armature to move freely without the fluid in those chambers impeding that motion.

The present inventor realized that it would be beneficial to dampen the armature motion which would provide better stability to the operation of an electrohydraulic valve.

### SUMMARY OF THE INVENTION

An electrohydraulic valve has a valve body with two fluid ports and a valve element for controlling flow of fluid between those fluid ports. For example, the valve element may comprise a spool that slides with in a bore in the valve body to selectively provide a fluid path between the two fluid ports.

A solenoid actuator includes a moveable armature that is operatively coupled to move the valve element. A first chamber is defined on one side of the armature and a second chamber is defined on another side of the armature. The armature has a fluid passageway between the first chamber and the second chamber. A damping piston is slideably located in the fluid passageway and has a damping orifice that provides a continuously open path for fluid to flow through the damping piston. A damping spring biases the damping piston into a normal position in the armature bore when the armature is in a steady state.

When the armature moves at low velocity, such as occurs upon movement from a steady state position, the pressure increases in either the first or second chamber causing fluid to flow from that chamber through the damping orifice in the damping piston. This reduces the effects of the pressure increase allowing the armature to move. At this time, the damping piston remains relatively stationary with respect to the armature. Thus, the damping spring does not contribute any force that damps the armature motion. This enables the armature and the associated valve element to be accurately positioned.

As the armature velocity increases, so too does pressure in the one chamber, which then causes the damping piston to move relative to the armature and compress or extend the damping spring. As a result of the damping piston movement, there is limited flow through the damping orifice and a minimal pressure differential across the damping piston and the armature. The lack of a significant pressure differential means that the force being added to the armature comes primarily from the damping spring.

Thus at low armature velocities, the damping effect is due essentially to the flow restriction provided by the damping orifice and at higher velocities, the dampening spring and motion of the damping piston primarily provide the damping effect.

In one aspect of the present invention, the damping spring biases the damping piston into a normal position when the electrohydraulic valve is in a steady state, and allows the damping piston to move bidirectionally from the normal position.

### BRIEF DESCRIPTION OF THE DRAWINGS

FIG. 1 is a cross sectional view through a first electrohydraulic control valve according to the present invention in which a workport is normally connected to an exhaust port in a deactivated state of the valve;

FIG. 2 is an enlarged cutaway section of an armature in FIG. 1; and

FIG. 3 is a cross sectional view through a second electrohydraulic control valve that normally connects the workport to a pressurized fluid supply port.

### DETAILED DESCRIPTION OF THE INVENTION

References herein to directional movement, such as left or right, refer to the motion of the components in the orientation illustrated in the drawings, which may not be the orientation of the components or the present control valve when attached to a machine.

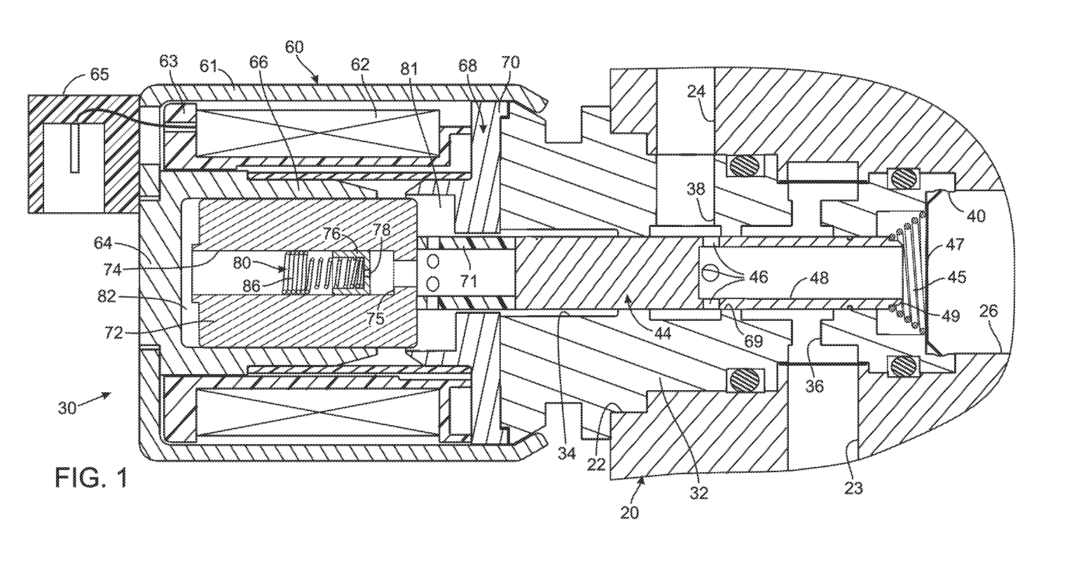

With initial reference to FIG. 1, an electrohydraulic first control valve 30 is illustrated inserted into an aperture 22 in a manifold 20. The manifold 20 has a supply passage 23 that conveys pressurized fluid from a source such as a pump (not shown) and a return passage 24 that conveys fluid back to a tank (not shown). The manifold 20 also has a device passage 26 to which is connected a hydraulic component that is controlled by the first control valve 30.

The first control valve 30 has a tubular valve body 32 with a longitudinal bore 34 and transverse openings which provide ports between the manifold passages and the longitudinal bore. Specifically, the longitudinal bore 34 is connected by a supply port 36 to the supply passage 23 and by an exhaust port 38 to the return passage 24. A workport 40 at the nose of the tubular valve body 32 opens into the manifold device passage 26.

A spool-like, tubular valve element 44 is slideably received within the bore 34 of the valve body 32 and is moved therein by a solenoid actuator 60. A central bore 48 extends between the opposite ends of the valve element. A plurality of radial apertures 46 communicate with the valve element bore 48, so that in selective positions of the valve element 44 fluid paths are provided between the workport 40 and either the supply port 36 or the exhaust port 38. In this type of proportional control valve, the flow to and from the workport goes through the center of the valve element. The first control valve 30, is referred to as having a normally low pressure state because in the deactivated state, the workport 40 is connected to the exhaust port 38.

A conical coil spring 45 is located adjacent the workport 40. A small diameter end of the conical coil spring 45 engages the end 49 of the valve element 44 and the larger end of the spring is held within the bore 34 of the valve body 32 by a retaining ring 47. The conical coil spring 45 biases the valve element into the illustrated normal position when current is not being applied to the solenoid actuator 60. In that illustrated position, the apertures 46 in the valve element open into the exhaust port 38, thereby providing a path between the exhaust port and the workport 40 when the valve is in the de-energized state.

The solenoid actuator 60 includes a can-like metal case 61 that contains an electromagnetic coil 62 which is wound on a non-magnetic bobbin 63, preferably formed of a plastic. A magnetically conductive first pole piece 64 has a cylindrical, tubular section 66 which extends into one end of the bobbin 63. A magnetically conductive, second pole piece 68 extends into the opposite end of the bobbin 63 and has an interior end that is spaced from the first pole piece 64. The second pole piece 68 has an outwardly projecting flange 70 that extends across the open end of the metal case 61 which is crimped around part of the valve body 32. The metal case 61 and the second pole piece 68 form a housing of the solenoid actuator 60. The engagement of the metal case 61 with the first and second pole pieces 64 and 68 provides a highly conductive magnetic flux path within the electromagnetic coil 62.

An armature 72 within the solenoid actuator 60 is slideably received within the first and second pole pieces 64 and 68. One end of the armature 72 defines a first chamber 81 within the second pole piece 68 and the opposite end of the armature defines a second chamber 82 within the first pole piece 64. These chambers in the solenoid actuator fill with the fluid that flows through the control valve 30. A steady state condition exists when substantially equal pressures are present in both the first and second chambers 81 and 82. The armature 72 has a bore 74 extending between opposite ends, thereby forming a fluid passageway between the first and second chambers 81 and 82. The armature bore 74 has a shoulder 75 therein at the end of the armature which faces the valve element 44.

The armature 72 slides within the first and second pole pieces 64 and 68 in response to a magnetic field that is produced by applying electric current to the electromagnetic coil 62 via a connector 65. For example, the electromagnetic coil 62 may be driven by a pulse width modulated (PWM) signal having a duty cycle that is varied in order to position the valve element 44 within the pole pieces. The armature 72 engages a driver tube 71 that is formed of a nonmagnetic material and that abuts the interior end of the valve element 44. Therefore, application of the electric current to the electromagnetic coil 62 moves the armature 72 to the right in FIG. 1, thereby pushing the valve element 44 to the right.

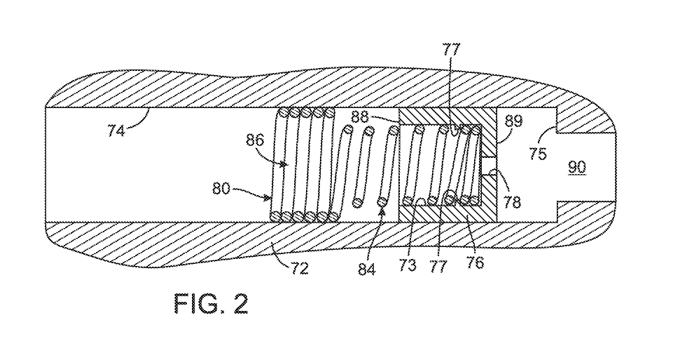

With reference to FIGS. 1 and 2, a damping piston 76 is located within the armature bore 74 and is able to slide longitudinally therein. The damping piston 76 is cup-shaped with an open first end 88 facing toward the armature bore shoulder 75 and through which a cavity 73 has a large opening. An opposite, closed second end 89 of the damping piston 76 has a damping orifice 78 extending there through providing fluid communication between the cavity and a portion 90 of the armature bore 74. The damping orifice 78 provides a fluid path that is continuously open on both sides of the damping piston 76, thereby always allowing fluid to be able to flow between the two solenoid chambers 81 and 82. The closed end 89 of the damping piston 76 has a cross-sectional area that is one-eighth the cross-sectional area of the armature 72, for example.

A damping spring 80 also is within the armature bore 74 and has a first section 84 of active coil turns that is contiguous with a second section 86 of dead coil turns with a larger diameter. The end of the damping spring 80 at the first section 84 of active coil turns extends into the damping piston cavity 73 and is affixed therein. For example, a plurality of tabs 77 project into the cavity 73 and capture a few of the active coil turns against the inner closed end 89 of the damping piston. The larger dead coil turns of the second section 86 of damping spring 80 are press fit into the armature bore 74 and thereby are held stationary in the bore at that position. Other mechanisms can be used to secure the damping spring to the damping piston and the armature. The damping spring 80 exerts both tension and compression forces, which allow the damping piston 76 to move bidirectionally in response to a pressure differential across the damping piston, as will be described. The spring's second section 86 of dead coil turns stops the sliding motion of the damping piston 76 in one direction and the armature bore shoulder 75 stops that motion in the opposite direction.

When electric current is applied to the electromagnetic coil 62, a magnetic field is produced within the solenoid actuator 60 that causes the armature 72 to move to the right in the drawing, thereby pushing the valve element 44 to the right as well. By applying a first level of electric current to the electromagnetic coil 62, the armature 72 is moved so that the valve element apertures 46 align with a land 69 in the valve body bore 34 between the supply port 36 and the exhaust port 38. In this position, the valve element apertures 46 are closed so that the bore 48 of the valve element 44 is not in communication with either the supply or the exhaust port 36 or 38. As a result, the workport 40 is closed off from the other two ports. By increasing the magnitude of electric current applied to the electromagnetic coil 62, the armature 72 and the valve element 44 move farther to the right in FIG. 1 aligning the apertures 46 with the supply port 36. This enables fluid from the supply port to flow through the apertures 46 and the valve element bore 48 toward the workport 40. Thereafter, when the application of electric current to the electromagnetic coil 62 is terminated, a magnetic field no longer acts on the armature 72. At that time, the conical coil spring 45 pushes the valve element 44 and thus the armature 72 leftward in FIG. 1 and into the illustrated normal position, where the valve element apertures 46 communicate with the exhaust port 38.

When the armature 72 moves within the pole pieces 64 and 68, the volume of one of the chambers 81 or 82 is expanding while the volume of the other chamber is correspondingly decreasing, depending on the direction of that movement. For that motion to continue, fluid within the chamber that is decreasing in volume must flow into the expanding chamber. For example, if the armature 72 is moving to the right in FIG. 1, that motion increases the pressure of the fluid within the first chamber 81 and decreases the pressure in the second chamber 82. This produces a difference in pressure that acts on the armature 72 and the damping piston 76 therein. The inter-chamber pressure difference causes the spring-loaded damping piston 76 to damp the armature motion in a predefined manner.

Continuing to refer to FIGS. 1 and 2, when the electric current applied to the solenoid actuator 60 changes gradually, the armature 72 moves at relatively low velocity. This results in a gradual increase of the pressure in one chamber 81 or 82 and a gradual decrease in the pressure in the other chamber 82 or 82. For example, assume that the armature is moving to the right, then the pressure increases in the first chamber 811 and decreases in the second chamber 82 creating a pressure differential across the damping piston 76. This change in pressure, however, is slow enough that the damping piston orifice 78 is able to convey sufficient flow to relieve pressure in the first chamber 81 so that motion of the damping piston 76 with respect to the armature 72 does not occur. As a consequence, the magnitude of that pressure differential at low velocities is not great enough to compress the damping spring 80. Therefore, the damping piston 76 moves with the armature 72 in the same direction. Thus at low velocity, the damping spring 80 has negligible contribution to dampening the armature motion.

If the damping piston 76 did not have the damping orifice 78, as the armature 72 moves to the right, the damping piston would have to move to the left to provide a larger volume in the right end of the armature bore 74 to compensate for the decrease in volume of the first chamber 81. The force necessary to compress the damping spring 80 and allow the damping piston 76 to move accordingly impedes motion of the armature 74 from the steady state of the valve. Hence a damping orifice 78 has been incorporated.

As the magnitude of electric current applied to the solenoid actuator 60 causes the armature 72 to move with greater velocity, the differential pressure across the damping piston 76 increases faster than can be relieved by the restricted flow through the damping orifice 78. This causes the damping piston 76 to move relative to the armature 72, which motion increases the volume of the portion of the armature bore 74 that opens into the higher pressure chamber. That action reduces the pressure differential. For example, when the armature is moving to the right in FIG. 1, the damping piston 76 moves to the left, thereby enlarging the armature bore portion 90 on the right side of the damping piston and reducing pressure in the first chamber 81. Therefore, there is a minimal or no pressure differential across the damping piston 76 and the armature 72. With a minimal pressure differential, there is limited flow through the damping orifice 78. As a consequence, the primary force being added to the armature 72 at this time comes from the damping spring 80.

As the damping piston 76 reaches a limit to its motion, either due to a physical restriction, such as the second section 86 of dead coil turns or the bore shoulder 75, or due to a flow forces attaining a peak level prior to that piston reaching the physical restriction, the damping piston begins to move along with the armature 72. This causes an increase in the pressure differential across the damping piston 76 as pressure increases in one solenoid chamber 81 or 82 and decreases in the other solenoid chamber. Previously, the motion of the damping piston 76 prevented a significant pressure change in the first and second solenoid chambers 81 and 82. The increased pressure differential causes fluid to flow through the damping orifice 78. The restrictive nature of the damping orifice 78 results in the damping piston 76 contributing an increasing amount of damping to the armature 72.

As the armature 72 reaches a steady state position, the damping piston 76 begins to catch up to the armature 72, thereby restoring the damping piston 76 to the normal position within the armature 72 due to the damping spring 80. This motion produces a pressure drop across the damping piston 76 and results in further damping of the armature 72. The timing of this damping mitigates overshoot in the armature's 72 final position and results in a quicker return to steady state.

Similarly when the electric current is removed from the solenoid actuator 60, the same process occurs within the armature 72 as the conical spring 45 returns the valve element 44 and the armature 72 to their normal positions. That is, the valve element and the armature move to the left in FIG. 1. The primary difference during this return motion is that the damping spring 80 is in tension as the armature moves 72. Therefore, the first control valve 30 exhibits damping in both directions of operation.

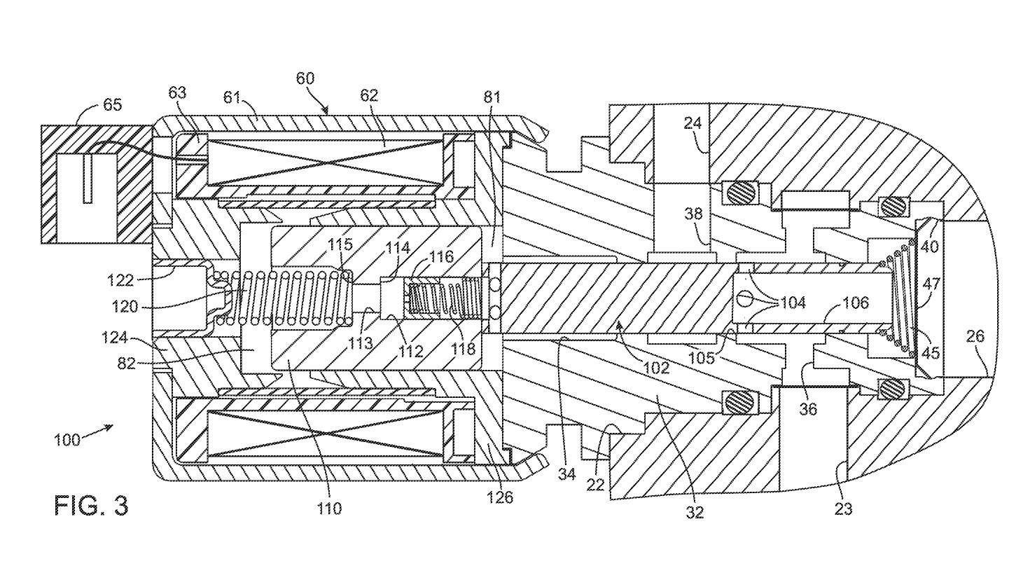

FIG. 3 illustrates a second control valve 100 in which components that are the same as those in the first control valve 30 have been assigned identical reference numerals. To simplify the description herein, those components will not be described in detail again. The second control valve 100 has a normally high pressure state, meaning that when electric current is not being applied to the electromagnetic coil 62, the valve element 102 is biased into a position in which a path is formed between the pressurized fluid supply port 36 and the workport 40. As a consequence, the valve element 102 is slightly different so that the apertures 104 that extend outward from the central bore 106 are located to communicate with the supply port 36 in that de-energized state. The valve element 102 directly abuts the armature 110.

The armature 110 also is slightly different as having an annular flange 113 that projects inwardly into a midsection of the armature bore 112 thereby forming first and second shoulders 114 and 115. The damping piston 116, having the same structure as piston 76 described previously, is located in the armature aperture 112 with the open end of the piston facing the valve element 102. The damping piston 116 is biased by a damping spring 118 that is identical to the previously described damping spring 80 for the first control valve 30. The smaller end of the damping spring 118 extends into the damping piston cavity and is affixed therein. The larger opposite end of the damping spring 118 is secured to the armature bore 112. The larger opposite end of the damping spring 118 stops the sliding motion of the damping piston 76 in one direction and the first armature bore shoulder 114 stops that motion in the opposite direction.

An armature spring 120 engages the second armature bore shoulder 115 and biases the armature 110 away from the exterior end of the solenoid actuator 60. That biasing pushes the armature 110 and the valve element 102 into the normally high pressure state of the valve that is illustrated. A spring adjustment cup 122 is press fit into an aperture in the first pole piece 124 by an amount that sets the force which the armature spring 120 exerts on the armature 110. A second pole piece 126 provides an interior cylindrical surface against which the armature 110 slides.

When electric current is applied to the electromagnetic coil 62 of the second control valve 100, a magnetic field is produced within the solenoid actuator 60 that pulls the armature 110 father into the electromagnetic coil, i.e., to the left in the orientation of the drawing. This action compresses the armature spring 120. The bias force applied to the valve element 102 by the conical coil spring 45 pushes the valve element against the end of the armature 110, thereby causing the valve element to follow the motion of the armature. Therefore, the valve element 102 initially moves into a position in which the transverse apertures 104 are covered by a land 105 within the valve body bore 34. In this position, the fluid communication which previously existed between the supply port 36 and the workport 40 is terminated. Thus, fluid is not allowed to flow between those ports. It should be understood that by applying the proper level of electric current to the electromagnetic coil 62, the valve element 102 may be maintained in this closed position.

Application of a greater level of electric current to the electromagnetic coil 62 enables the armature 110 and the valve element 102 to move farther leftward into a position at which the apertures 104 in the valve element open into the exhaust port 38. Fluid communication now is established between the workport 40 and the exhaust port 38 through the valve element central bore 106 and the apertures 104.

As the armature 110 of the second control valve 100 moves, fluid is forced to flow between the first and second chambers 81 and 82 in the solenoid actuator 60. The direction of that flow depends upon the direction in which the armature 110 is moving. For example, when the armature 110 moves to the left in FIG. 3, the second chamber 82 decreases in volume and the first chamber 81 increases in volume thus forcing fluid from the second chamber into the first chamber. This increases pressure in the second chamber 82 which pressure acts on the armature 110 and the damping piston 116 therein. That pressure change causes the spring-loaded damping piston 116 to damp the armature motion in the same manner as described with respect to the first control valve 30.

Thereafter, when the electric current is removed from being applied to the electromagnetic coil 62, the force of the armature spring 120 returns the armature 110 and the abutting valve element 102 to the normal position illustrated in FIG. 3. The pressure changes occurring in the first and second chambers 81 and 82 due to that armature motion are similar to, but reversed from those produced when the solenoid actuator 60 was energized. In response, the damping piston 116 operates in a reverse manner. Therefore the damping piston 116 provides damping of the bidirectional movement of the armature 110 and valve element 102 in the second control valve 100.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. An electrohydraulic valve comprising:
a valve body having fluid passage;
a valve element for selectively controlling flow of fluid through the fluid passage;
a solenoid actuator having a moveable armature operatively coupled to move the valve element and defining a first chamber on one side of the armature and a second chamber on another side of the armature, wherein the armature has a passageway between the first chamber and the second chamber;
a damping piston moveably located in the passageway and having an orifice that provides a continuously open path for fluid to flow through the damping piston; and
a damping spring biasing the damping piston with respect to the armature.

2. The electrohydraulic valve as recited in claim 1 wherein motion of the damping piston damps motion of the armature.

3. The electrohydraulic valve as recited in claim 1 wherein when the armature moves from a steady state, fluid flow through the orifice precludes substantial motion of the damping piston with respect to the armature, and thereafter as velocity of the armature increases, the damping piston moves with respect to the armature and force from the damping spring damps motion of the armature.

4. The electrohydraulic valve as recited in claim 1 further comprising a stop formed within the passageway for limiting motion of the damping piston.

5. The electrohydraulic valve as recited in claim 1 wherein the damping piston comprises a first end through which a cavity opens and a second end from which the orifice extends to the cavity.

6. The electrohydraulic valve as recited in claim 5 wherein the damping spring has a first end secured within the cavity of the damping piston and a second end secured within the passageway.

7. The electrohydraulic valve as recited in claim 1 wherein the damping spring has one end abutting the damping piston and another end engaging the armature.

8. The electrohydraulic valve as recited in claim 1 wherein the damping spring comprises a first section affixed to the damping piston and having a first diameter, and second section having a second diameter that is larger than the first diameter, wherein the second section securely engages a surface of the passage.

9. The electrohydraulic valve as recited in claim 1 wherein the damping spring biases the damping piston into a normal position when the electrohydraulic valve is in a steady state, and allows the damping piston to move bidirectionally from the normal position.

10. The electrohydraulic valve as recited in claim 1 further comprising an armature spring which biases the armature toward the valve element.

11. An electrohydraulic valve comprising:
a valve body with two fluid ports;
a valve element for controlling flow of fluid between the two fluid ports;
a solenoid actuator comprising a moveable armature operatively coupled to the valve element and defining a first chamber on one side of the armature and a second chamber on another side of the armature, the armature having an armature bore extending between the first and second chambers;
a damping piston slideably located in the armature bore and having a first end surface facing toward the first chamber and second end surface facing toward the second chamber, damping piston including an orifice that forms a continuously open fluid path between the first and second end surfaces; and
a damping spring biasing the damping piston into a normal position in the armature bore when the electrohydraulic valve is in a steady state.

12. The electrohydraulic valve as recited in claim 11 wherein motion of the damping piston damps motion of the armature.

13. The electrohydraulic valve as recited in claim 11 wherein when the armature moves from a steady state, fluid flow through the orifice precludes substantial motion of the damping piston with respect to the armature, and thereafter as velocity of the armature increases, the damping piston moves with respect to the armature and force from the damping spring damps motion of the armature.

14. The electrohydraulic valve as recited in claim 11 further comprising a stop formed within the armature bore for limiting motion of the damping piston.

15. The electrohydraulic valve as recited in claim 11 wherein the damping piston comprises a cavity extending inwardly through the first end surface, wherein the orifice extends between the cavity and the second end surface.

16. The electrohydraulic valve as recited in claim 15 wherein the damping spring has a first end secured within the cavity of the damping piston and a second end secured against a surface of the armature bore.

17. The electrohydraulic valve as recited in claim 11 wherein the damping spring has one end abutting the damping piston and another end secured to the armature.

18. The electrohydraulic valve as recited in claim 11 wherein the damping spring comprises a first section affixed to the damping piston and having a first diameter, and second section having a second diameter that is larger than the first diameter wherein the second section securely engages a surface of the armature bore.

19. The electrohydraulic valve as recited in claim 11 wherein the damping spring allows the damping piston to move bidirectionally in the armature bore from the normal position.

20. The electrohydraulic valve as recited in claim 11 further comprising an armature spring which biases the armature toward the valve element.
